(19) United States
(12) Patent Application Publication
(10) Pub. No.: US 2026/0235169 A1
(43) Pub. Date: Aug. 13, 2026

(54) TORQUE LIMITER AND POWER TRANSMISSION DEVICE

(71) Applicant: EXEDY Corporation, Osaka (JP)

(72) Inventor: Masahiro MAEDA, Neyagawa-shi, Osaka (JP)

(21) Appl. No.: 19/448,416

(22) Filed: Jan. 14, 2026

(30) Foreign Application Priority Data
Feb. 13, 2025 (JP) 2025-021395

(51) Int. Cl. F16D 13/64

(52) U.S. Cl. CPC F16D 13/64; F16D 2300/22

(57) ABSTRACT

A plurality of auxiliary plates are attached to a support plate, disposed radially outside the support plate and are aligned in an annular shape. A friction material is disposed between the support plate and a disc spring in an axial direction. The friction material is disposed adjacent to the support plate and each of the plurality of auxiliary plates. The support plate includes a plurality of engaging slits extending radially inward from an outer peripheral surface thereof. Each of the plurality of auxiliary plates includes a plate body and an engaging tab. The plate body extends in a circumferential direction. The engaging tab extends radially inward from the plate body and is engaged with one of the plurality of engaging slits. The engaging tab is hooked on an interior of one of the plurality of engaging slits to restrict each of the plurality of auxiliary plates from moving radially outward.

### CROSS-REFERENCE TO RELATED APPLICATIONS

This application is based on and claims the priority benefit of Japanese application No. 2025-021395 filed on February 13, 2025, the contents of which are incorporated herein by reference.

### TECHNICAL FIELD

The present invention relates to a torque limiter and a power transmission device.

### BACKGROUND

A power transmission device including a torque limiter has been proposed to prevent transmission of an excessive torque. For example, a power transmission device disclosed in Japan Laid-open Patent Application Publication No. 2022-55616 includes a damper unit and a torque limiter. The torque limiter includes a clutch composed of a plurality of plates; then, transmission of an excessive torque is prevented by slippage of the clutch. The torque limiter includes a support plate for supporting a friction material and also includes a disc spring for pressing the clutch.

### SUMMARY OF THE INVENTION

Increase in outer diameter of the friction material has been demanded in the torque limiter configured as described above. In view of this, it is an object of the present invention to provide a torque limiter in which increase in outer diameter of a friction material is enabled.

A torque limiter according to a first aspect includes a first side plate, a support plate, a plurality of auxiliary plates, a disc spring, and a first friction material. The first side plate has an annular shape. The support plate has an annular shape. The support plate is disposed away from the first side plate at an interval in an axial direction. The plurality of auxiliary plates are attached to the support plate. The plurality of auxiliary plates are disposed radially outside the support plate. The plurality of auxiliary plates are aligned in an annular shape. The disc spring is disposed between the first side plate and the support plate in the axial direction. The first friction material is disposed between the support plate and the disc spring in the axial direction. The first friction material is disposed adjacent to the support plate and each of the plurality of auxiliary plates. The support plate includes a plurality of engaging slits extending radially inward from an outer peripheral surface thereof. The each of the plurality of auxiliary plates includes a plate body and an engaging tab. The plate body extends in a circumferential direction. The engaging tab extends radially inward from the plate body. The engaging tab is engaged with one of the plurality of engaging slits. The engaging tab is configured to be hooked on an interior of the one of the plurality of engaging slits so as to restrict the each of the plurality of auxiliary plates from moving radially outward.

A conventional torque limiter is configured such that the friction material is supported by the support plate; hence, it has been impossible for the friction material to have a larger outer diameter than the support plate. By contrast, in the torque limiter according to the first aspect, the plurality of auxiliary plates are attached to the support plate; hence, the friction material can be supported by the support plate and the plurality of auxiliary plates. Because of this, it is made possible for the friction material to have a larger outer diameter than the support plate. As a result, even when the support plate is limited in outer diameter, increase in outer diameter of the friction material is enabled. Besides, each of the plurality of auxiliary plates is configured to be hooked on the interior of one of the plurality of engaging slits of the support plate; hence, it is made possible to inhibit the occurrence of such a situation that each of the plurality of auxiliary plates is moved radially outward by a centrifugal force.

A torque limiter according to a second aspect relates to the torque limiter according to the first aspect and is configured as follows. The engaging tab includes an extending portion and a hook portion. The extending portion extends radially inward from the plate body. The hook portion extends from the extending portion in the circumferential direction.

A torque limiter according to a third aspect relates to the torque limiter according to the second aspect and is configured as follows. The each of plurality of the auxiliary plates includes a pair of the engaging tabs. The hook portion of the one of the pair of engaging tabs and the hook portion of the other of the pair of engaging tabs extend toward each other in the circumferential direction.

A torque limiter according to a fourth aspect relates to the torque limiter according to the third aspect and is configured as follows. The support plate includes a pair of protruding portions protruding in the axial direction. The pair of engaging tabs is disposed between the pair of protruding portions in the circumferential direction.

A torque limiter according to a fifth aspect relates to the torque limiter according to any of the first to fourth aspects and is configured as follows. The first friction material includes a groove. The groove is provided on a surface of the first friction material that is disposed adjacent to the support plate and the each of the plurality of auxiliary plates. The groove opens radially outward. The groove overlaps with a boundary between the engaging tab and the one of the plurality of engaging slits as seen in the axial direction.

A torque limiter according to a sixth aspect relates to the torque limiter according to any of the first to fifth aspects and further includes a second side plate, a pressure plate, and a second friction material. The second side plate is disposed to interpose the support plate, the each of the plurality of auxiliary plates, the disc spring, and the first friction material together with the first side plate therebetween. The second side plate has an annular shape. The pressure plate is disposed between the disc spring and the first friction material in the axial direction. The second friction material is disposed between the support plate and the second side plate in the axial direction.

A torque limiter according to a seventh aspect relates to the torque limiter according to any of the first to fifth aspects and further includes a second side plate, a pressure plate, and a second friction material. The second side plate is disposed to interpose the support plate, the each of the plurality of auxiliary plates, the disc spring, and the first friction material together with the first side plate therebetween. The second side plate has an annular shape. The pressure plate is disposed between the disc spring and the first friction material in the axial direction. The second friction material is disposed between the support plate and the second side plate in the axial direction. The first friction material includes a first through hole penetrating therethrough in the axial direction. The second friction material includes a second through hole penetrating therethrough in the axial direction. The support plate includes a first protruding portion, a second protruding portion, a first region, and a second region. The first protruding portion protrudes toward the first friction material and is engaged with the first through hole. The second protruding portion protrudes toward the second friction material and is engaged with the second through hole. The first region is defined by one pair of engaging slits disposed adjacent to each other in the circumferential direction among the plurality of engaging slits and is provided with the first protruding portion. The second region is defined by another pair of engaging slits disposed adjacent to each other in the circumferential direction among the plurality of engaging slits and is provided with the second protruding portion. The first region is shaped to bend toward the first friction material and is extended straight when sandwiched by the pressure plate and the second side plate. The second region is shaped to bend toward the second friction material and is extended straight when sandwiched by the pressure plate and the second side plate.

A torque limiter according to an eight aspect relates to the torque limiter according to any of the first to seventh aspects and is configured as follows. An inner peripheral edge of the disc spring is disposed radially outside an outer peripheral edge of the support plate. Besides, the inner peripheral edge of the disc spring is disposed radially inside an outer peripheral edge of the each of the plurality of auxiliary plates. According to the configuration, it is made possible to sandwich the first friction material by the disc spring and the plurality of auxiliary plates; hence, even when the disc spring and the support plate are taken together from a sheet of plate by nested-based manufacturing, it is made possible to evenly apply a load to the first friction material.

A torque limiter according to a ninth aspect relates to the torque limiter according to any of the first to eighth aspects and is configured as follows. The disc spring is equal in plate thickness to the support plate.

A power transmission device according to a tenth aspect includes the torque limiter recited in any of the first to ninth aspects and a damper unit. The damper unit includes an input rotor, an output rotor, and an elastic member. The input rotor is configured to be rotated unitarily with the support plate. The elastic member elastically couples the input rotor and the output rotor therethrough to each other.

Overall, according to the present invention, an increase in outer diameter of a friction material is enabled.

### BRIEF DESCRIPTION OF THE DRAWINGS

FIG. 1 is a front view of a power transmission device.

FIG. 2 is a cross-sectional view of the power transmission device taken along line II-II in FIG. 1.

FIG. 3 is a front view of a support plate.

FIG. 4 is a cross-sectional view of a torque limiter in a pre-assembled state.

FIG. 5 is a cross-sectional view of the torque limiter in an assembled state.

FIG. 6 is a front view of the support plate to which auxiliary plates are attached.

FIG. 7 is a front view of each auxiliary plate.

FIG. 8 is a front view of a first friction material.

FIG. 9 is a cross-sectional view of the first friction material taken along arrowed line IX-XI in FIG. 8.

FIG. 10 is an enlarged front view of the support plate to which the first friction material and the auxiliary plates are attached.

FIG. 11 is a front view of a sheet of plate from which the support plate, a disc spring, and a plurality of auxiliary plates are taken out.

FIG. 12 is a front view of auxiliary plates attached to the support plate in a modification.

FIG. 13 is a front view of auxiliary plates attached to the support plate in another modification.

FIG. 14 is a front view of auxiliary plates attached to the support plate in yet another modification.

### DETAILED DESCRIPTION

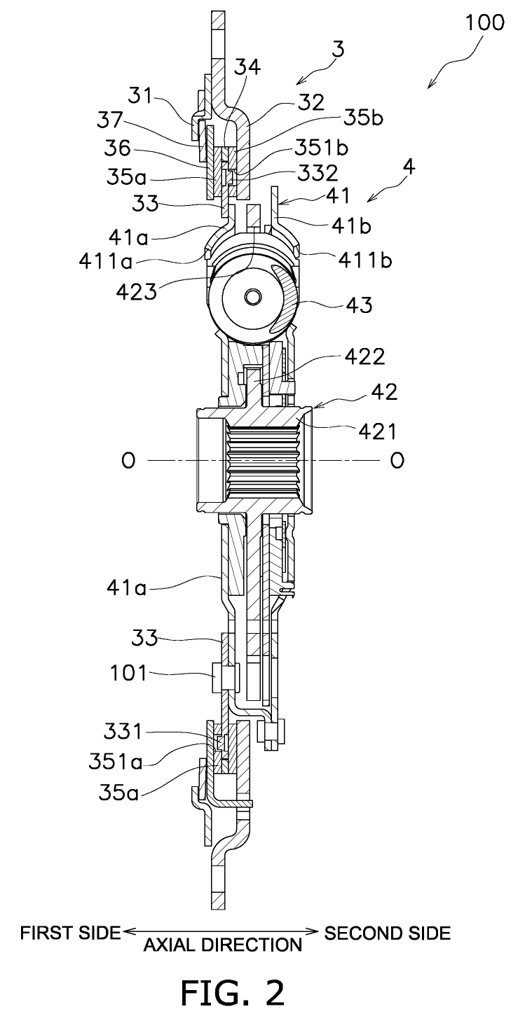

A torque limiter 3 and a power transmission device 100 according to the present preferred embodiment will be hereinafter explained with reference to drawings. It should be noted that in the following explanation, the term “axial direction” refers to an extending direction of a rotational axis O for both the torque limiter 3 and the power transmission device 100. On the other hand, the term “circumferential direction” refers to a circumferential direction of an imaginary circle about the rotational axis O, whereas the term “radial direction” refers to a radial direction of the imaginary circle about the rotational axis O. Besides, the term “first side in the axial direction” means the left side in FIG. 2, whereas the term “second side in the axial direction” means the right side in FIG. 2.

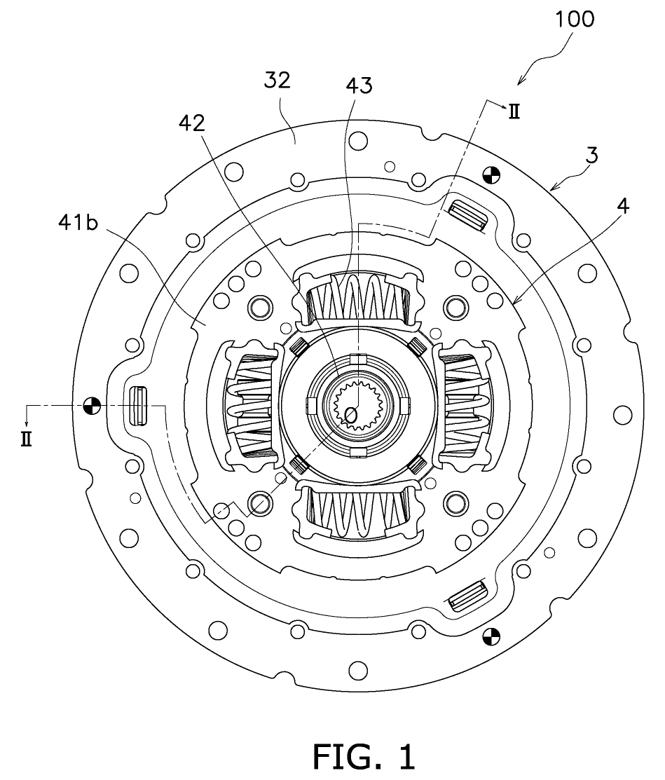

FIG. 1 is a front view of the power transmission device 100, whereas FIG. 2 is a cross-sectional view of the power transmission device 100 taken along line II-II in FIG. 1. As shown in FIGS. 1 and 2, the power transmission device 100 includes the torque limiter 3 and a damper unit 4. Basically speaking, the torque limiter 3 and the damper unit 4 are rotated unitarily with each other. The power transmission device 100 is installed between an internal combustion engine (omitted in illustration) and an output-side member (omitted in illustration). It should be noted that the output-side member is, for instance, an electric motor, an electric power generator, a transmission, or so forth. The power transmission device 100 is attached to a flywheel (omitted in illustration). For example, in FIG. 2, the internal combustion engine is disposed on the left side of the power transmission device 100, whereas the output-side member is disposed on the right side of the power transmission device 100. The power transmission device 100 is configured to limit a torque transmitted between the internal combustion engine and the output-side member and attenuate fluctuations in torque.

### Damper Unit

The damper unit 4 is attached to the torque limiter 3. The damper unit 4 is configured to attenuate fluctuations in rotation. The damper unit 4 includes an input rotor 41, an output rotor 42, and a plurality of elastic members 43.

### Input Rotor

The input rotor 41 is rotated unitarily with a support plate 33 in the torque limiter 3 (to be described). The input rotor 41 includes a first plate 41a and a second plate 41b. Each of the first and second plates 41a and 41b is an annular member including a center hole. The first and second plates 41a and 41b are rotated unitarily with each other. Besides, the first and second plates 41a and 41b are axially immovable relative to each other.

The first and second plates 41a and 41b are disposed away from each other at an interval in the axial direction. The second plate 41b is disposed on the second side of the first plate 41a in the axial direction.

The first plate 41a includes a plurality of window portions 411a, while the second plate 41b includes a plurality of window portions 411b. It should be noted that in the present preferred embodiment, the first plate 41a includes four window portions 411a, while the second plate 41b includes four window portions 411b; however, the window portions 411a, 411b are not limited in number to this.

Not only the window portions 411a but also the window portions 411b are disposed away from each other at intervals in the circumferential direction. Not only the window portions 411a but also the window portions 411b are configured to accommodate the elastic members 43, respectively.

### Output Rotor

The output rotor 42 is configured to transmit the torque, outputted thereto from the input rotor 41, to the output-side member. The output rotor 42 is disposed axially between the first and second plates 41a and 41b. The output rotor 42 is disposed to be rotatable relative to the first and second plates 41a and 41b.

The output rotor 42 includes a hub 421 and a flange plate 422. The hub 421 and the flange plate 422 are integrated as a single member; alternatively, the hub 421 and the flange plate 422 may be separated as different members.

The hub 421 has a tubular shape and is disposed in the center hole of the first plate 41a and that of the second plate 41b. The hub 421 is provided with a spline hole, extending in the axial direction, in an inner peripheral part thereof. The spline hole enables an input shaft of the output-side member to be spline-coupled thereto.

The flange plate 422 radially extends from the outer peripheral surface of the hub 421. The flange plate 422 has an annular shape. The flange plate 422 is disposed to be rotatable relative to the first and second plates 41a and 41b. The flange plate 422 is disposed axially between the first and second plates 41a and 41b.

The flange plate 422 includes a plurality of accommodation holes 423. It should be noted that in the present preferred embodiment, the flange plate 422 includes four accommodation holes 423; however, the accommodation holes 423 are not limited in number to this. The accommodation holes 423 are disposed away from each other at intervals in the circumferential direction. The accommodation holes 423 are configured to accommodate the elastic members 43, respectively. The accommodation holes 423 are set in place to overlap with not only the window portions 411a but also the window portions 411b, respectively, as seen in the axial direction.

### Elastic Members

The elastic members 43 are configured to elastically couple the input rotor 41 and the output rotor 42 in a rotational direction. The elastic members 43 are, for instance, coil springs.

The elastic members 43 are accommodated in the accommodation holes 423 of the output rotor 42, respectively. Besides, the elastic members 43 are accommodated in not only the window portions 411a of the first plate 41a but also the window portions 411b of the second plate 41b, respectively.

### Torque Limiter

The torque limiter 3 is disposed to be rotatable about the rotational axis O. The torque limiter 3 is disposed on the second side of the flywheel in the axial direction. The torque limiter 3 has an annular shape. The torque limiter 3 is attached to the flywheel.

The torque limiter 3 is configured to limit the torque transmitted between the flywheel and the damper unit 4. In other words, the torque limiter 3 is configured to restrict transmission of the torque in the power transmission device 100 when the torque has a magnitude of a predetermined value or greater.

The torque limiter 3 includes a first side plate 31, a second side plate 32, the support plate 33, a plurality of auxiliary plates 34, a first friction material 35a, a second friction material 35b, a pressure plate 36, and a disc spring 37.

### First and Second Side Plates

The first and second side plates 31 and 32 are attached to the flywheel. The first and second side plates 31 and 32 are rotated unitarily with the flywheel. Each of the first and second side plates 31 and 32 has an annular shape. The second side plate 32 is disposed away from the first side plate 31 at an interval in the axial direction. The second side plate 32 is disposed on the second side of the first side plate 31 in the axial direction. The support plate 33, the auxiliary plates 34, the first friction material 35a, the second friction material 35b, the pressure plate 36, and the disc spring 37 are disposed between the first and second side plates 31 and 32. The second side plate 32 is larger in plate thickness than the first side plate 31.

### Support Plate

The support plate 33 is an annular plate. The support plate 33 is disposed to be rotatable about the rotational axis O. The support plate 33 is disposed away from the first side plate 31 at an interval in the axial direction.

The support plate 33 is attached to the input rotor 41. When described in detail, the support plate 33 is attached to the first plate 41a. For example, the support plate 33 is attached to the first plate 41a by one or more fastening members 101. The support plate 33 is rotated unitarily with the input rotor 41. It should be noted that the support plate 33 is separated from the first plate 41a as a discrete member; alternatively, the support plate 33 may be integrated with the first plate 41a as a single member.

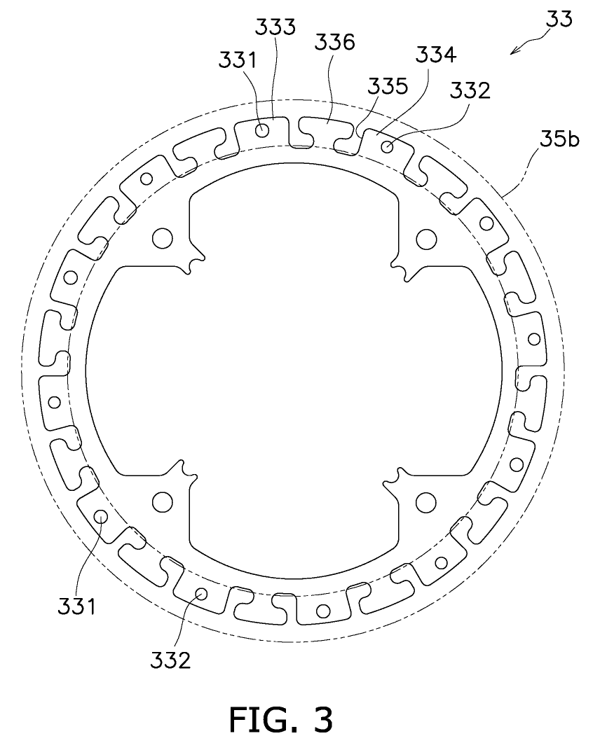

FIG. 3 is a front view of the support plate 33. It should be noted that the second friction material 35b is also depicted with dashed two-dotted line in FIG. 3. As shown in FIG. 3, the support plate 33 includes a plurality of engaging slits 335. Each engaging slit 335 extends radially inward from the outer peripheral surface of the support plate 33. When described in detail, each engaging slit 335 extends radially inward from the outer peripheral surface of the support plate 33 and then extends at the distal end thereof in the circumferential direction. When the engaging slits 335 disposed adjacent to each other are paired off, each pair of engaging slits 335 is shaped such that the distal ends thereof extend toward each other. Thus, the support plate 33 includes a plurality of pairs of engaging slits 335 configured as herein described.

The radially inner ends of the engaging slits 335 are disposed radially inside the inner peripheral edges of the first and second friction materials 35a and 35b. In other words, the engaging slits 335 are exposed in part from the first and second friction materials 35a and 35b as seen in the axial direction.

The engaging slits 335 open radially outward. The engaging slits 335 are provided in an outer peripheral part of the support plate 33. The engaging slits 335 penetrate the support plate 33 in the axial direction. The engaging slits 335 are disposed away from each other at intervals in the circumferential direction.

As shown in FIGS. 2 and 3, the support plate 33 includes a plurality of first protruding portions 331 and a plurality of second protruding portions 332. The first protruding portions 331 and the second protruding portions 332 are alternately disposed in the circumferential direction. The first protruding portions 331 and the second protruding portions 332 are disposed in common on the circumference of an imaginary circle. It should be noted that in the following explanation, the first protruding portions 331 and the second protruding portions 332 will be collectively referred to as protruding portions 331 and 332. The protruding portions 331 and 332 protrude in the axial direction.

The first protruding portions 331 protrude toward the first friction material 35a. In other words, the first protruding portions 331 protrude to the first side in the axial direction. The first protruding portions 331 are engaged with first through holes 351a of the first friction material 35a (to be described), respectively.

The second protruding portions 332 protrude toward the second friction material 35b. In other words, the second protruding portions 332 protrude to the second side in the axial direction. The second protruding portions 332 are engaged with second through holes 351b of the second friction material 35b (to be described), respectively.

As shown in FIG. 3, the support plate 33 includes a plurality of first regions 333, a plurality of second regions 334, and a plurality of third regions 336. Each first region 333 is defined by each pair of engaging slits 335 disposed adjacent to each other in the circumferential direction. Each first region 333 is provided with each first protruding portion 331. In other words, each first region 333 corresponds to a part of a region between each pair of engaging slits 335 disposed adjacent to each other in the circumferential direction, i.e., a part in which each first protrusion 331 is provided.

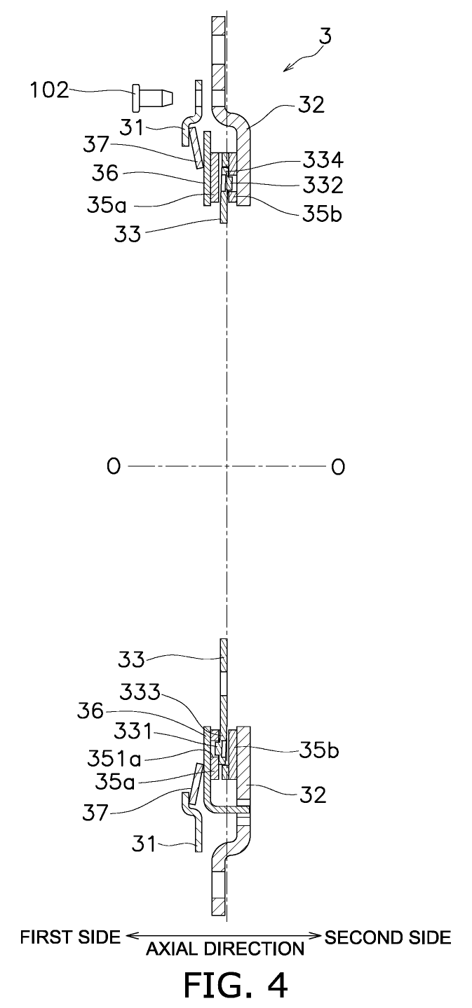

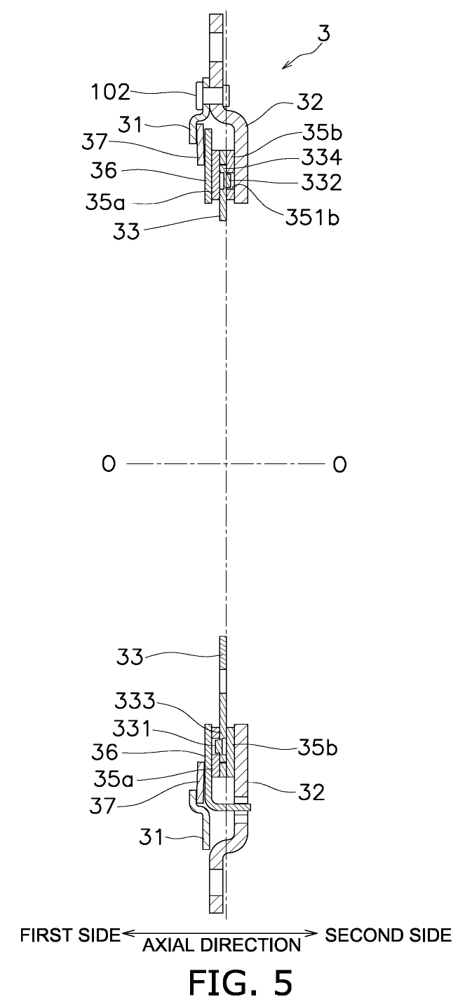

FIG. 4 is a cross-sectional view of the torque limiter 3 in a pre-assembled state, whereas FIG. 5 is a cross-sectional view of the torque limiter 3 in an assembled state. As shown in FIG. 4, in the pre-assembled state of the torque limiter 3, before the support plate 33 is applied with a load acting in the axial direction, the first regions 333 are bent toward the first friction material 35a. In other words, the first regions 333 are bent to the first side in the axial direction. Because of this, it is made easy to fit the first protruding portions 331 of the support plate 33 into the first through holes 351a of the first friction material 35a.

As shown in FIG. 5, in the assembled state of the torque limiter 3, i.e., when the first side plate 31 is fastened to the second side plate 32 by a plurality of rivets 102, the support plate 33 including the first regions 333 is sandwiched by the second side plate 32 and the pressure plate 36. As a result, the support plate 33 including the first regions 333 is applied with a load acting the axial direction, whereby the first regions 333 bent so far in the axial direction are radially extended in a straight manner.

As shown in FIG. 3, each second region 334 is defined by each pair of engaging slits 335 disposed adjacent to each other in the circumferential direction. Each second region 334 is provided with each second protruding portion 332. In other words, each second region 334 corresponds to a part of a region between each pair of engaging slits 335 disposed adjacent to each other in the circumferential direction, i.e., a part in which each second protruding portion 332 is provided.

The first regions 333 and the second regions 334 are alternately disposed in the circumferential direction. Each third region 336 is interposed between each first region 33 and each second region 334. Only the first protruding portion 331, only the second protruding portion 332, or neither of the first and second protruding portions 331 and 332 is provided in the region between each pair of engaging slits 335. Both the first and second protruding portions 331 and 332 are not provided in the region between each pair of engaging slits 335.

As shown in FIG. 4, in the pre-assembled state of the torque limiter 3, i.e., before the support plate 33 is applied with a load acting in the axial direction, the second regions 334 are bent toward the second friction material 35b. In other words, the second regions 334 are bent to the second side in the axial direction. Because of this, it is made easy to fit the second protruding portions 332 of the support plate 33 into the second through holes 351b of the second friction material 35b.

As shown in FIG. 5, when the torque limiter 3 is assembled, i.e., when the first side plate 31 is fastened to the second side plate 32 by the plural rivets 102, the support plate 33 including the second regions 334 is sandwiched by the second side plate 32 and the pressure plate 36. As a result, the support plate 33 including the second regions 334 is applied with a load acting in the axial direction, whereby the second regions 334 bent so far in the axial direction are radially extended in a straight manner.

As shown in FIG. 3, each third region 336 is disposed circumferentially between each first region 333 and each second region 334. Each third region 336 is not provided with the protruding portions 331 and 332. The distal ends of the engaging slits 335 extend toward the third regions 336 in the circumferential direction.

### Auxiliary Plate

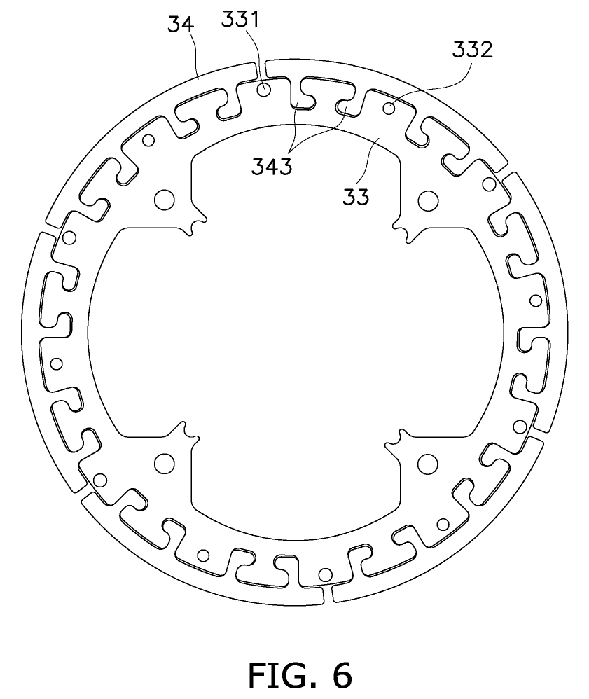

FIG. 6 is a front view of the auxiliary plates 34 attached to the support plate 33. As shown in FIG. 6, the auxiliary plates 34 are disposed radially outside the support plate 33. The auxiliary plates 34 are attached to the support plate 33. The auxiliary plates 34 are rotated unitarily with the support plate 33.

In the present preferred embodiment, the torque limiter 3 includes six auxiliary plates 34. The auxiliary plates 34 are aligned in an annular shape. In other words, the auxiliary plates 34 are aligned in the circumferential direction. The auxiliary plates 34 are disposed away from each other at intervals in the circumferential direction. It should be noted that the auxiliary plates 34 may be in contact with each other.

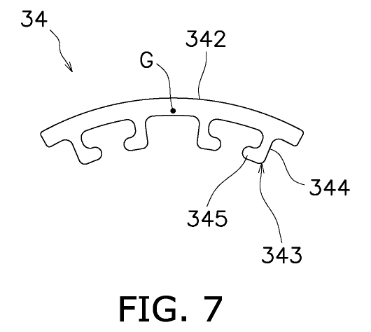

FIG. 7 is a front view of each auxiliary plate 34. As shown in FIG. 7, each auxiliary plate 34 includes a plate body 342 and a plurality of engaging tabs 343. It should be noted that in the present preferred embodiment, each auxiliary plate 34 includes four engaging tabs 343. The plate body 342 extends in the circumferential direction. The plate body 342 is made in the shape of an arc of a circle with the rotational axis O as the center thereof.

The engaging tabs 343 extend radially inward from the plate body 342. The engaging tabs 343 are disposed away from each other at intervals in the circumferential direction. The engaging tabs 343 are engaged with corresponding ones of the engaging slits 335. Each engaging tab 343 is identical in extending direction to the corresponding engaging slit 335. Each engaging tab 343 is substantially identical in shape to the corresponding engaging slit 335. The engaging tabs 343 are engaged with the corresponding engaging slits 335, whereby each auxiliary plate 34 is attached to the support plate 33.

Each engaging tab 343 is configured to be hooked on the interior of each engaging slit 335 corresponding thereto. Because of this, even when a centrifugal force acts on each auxiliary plate 34 by the rotation of the power transmission device 100, each engaging tab 343 is hooked on the inner wall surface of each engaging slit 335 corresponding thereto, whereby each auxiliary plate 34 is restricted from moving radially outward; consequently, each auxiliary plate 34 can be prevented from being detached from the support plate 33.

When described in detail, each auxiliary plate 34 includes at least a pair of engaging tabs 343. It should be noted that in the present preferred embodiment, each auxiliary plate 34 includes four engaging tabs 343. In other words, each auxiliary plate 34 includes two pairs of engaging tabs 343.

Each engaging tab 343 includes an extending portion 344 and a hook portion 345. The extending portion 344 extends radially inward from the plate body 342. In other words, the extending portion 344 is a radially extending portion of each engaging tab 343. The extending portion 344 extends toward the rotational axis O.

The hook portion 345 extends from the extending portion 344 in the circumferential direction. In other words, the hook portion 345 is a circumferentially extending portion of each engaging tab 343. The hook portion 345 extends from the distal end of the extending portion 344 in the circumferential direction. In each pair of engaging tabs 343 disposed adjacent to each other in the circumferential direction, the hook portions 345 extend toward each other in the circumferential direction. It should be noted that in each pair of engaging tabs 343 disposed adjacent to each other in the circumferential direction, the hook portions 345 are disposed away from each other at an interval in the circumferential direction.

In each auxiliary plate 34, one pair of engaging tabs 343 is disposed to interpose the center of gravity (G) of each auxiliary plate 34 together with the other pair of engaging tabs 343 therebetween in the circumferential direction. Accordingly, it is made possible to more reliably prevent that each auxiliary plate 34 is moved radially outward and is thereby detached from the support plate 33.

As shown in FIG. 6, each pair of engaging tabs 343 is disposed circumferentially between each pair of protruding portions 331 and 332. When described in detail, each pair of engaging tabs 343, shaped to be opposed to each other at the hook portions 345 thereof, are disposed circumferentially between each first protruding portion 331 and each second protruding portion 332. It should be noted that the protruding portions 331 and 332 are not disposed between each pair of engaging tabs 343 shaped to be opposed to each other at the hook portions 345 thereof.

### Friction Materials

As shown in FIG. 2, the first friction material 35a is disposed axially between the support plate 33 and the disc spring 37. When described in detail, the first friction material 35a is disposed axially between the support plate 33 and the pressure plate 36. The first friction material 35a is disposed adjacent to the support plate 33 and the auxiliary plates 34 in the axial direction.

The first friction material 35a includes the first through holes 351a. The first through holes 351a penetrate the first friction material 35a in the axial direction. The first friction material 35a is attached to the support plate 33. When described in detail, the first protruding portions 331 of the support plate 33 are engaged with the first through holes 351a of the first friction material 35a, whereby the first friction material 35a is attached to the support plate 33. The first friction material 35a is rotated unitarily with the support plate 33.

The first friction material 35a has an annular shape. The first friction material 35a extends across the support plate 33 and the auxiliary plates 34. In other words, the first friction material 35a overlaps with both the support plate 33 and the auxiliary plates 34 as seen in the axial direction. The first friction material 35a has an inner diameter smaller than an outer diameter of the support plate 33. The first friction material 35a has an outer diameter larger than that of the support plate 33. Besides, the outer diameter of the first friction material 35a is less than or equal to that of each auxiliary plate 34. It should be noted that in the present preferred embodiment, the outer diameter of the first friction material 35a is substantially equal to that of each auxiliary plate 34. The outer diameter of each auxiliary plate 34 herein means the length from the rotational axis O to the outer peripheral edge of each auxiliary plate 34.

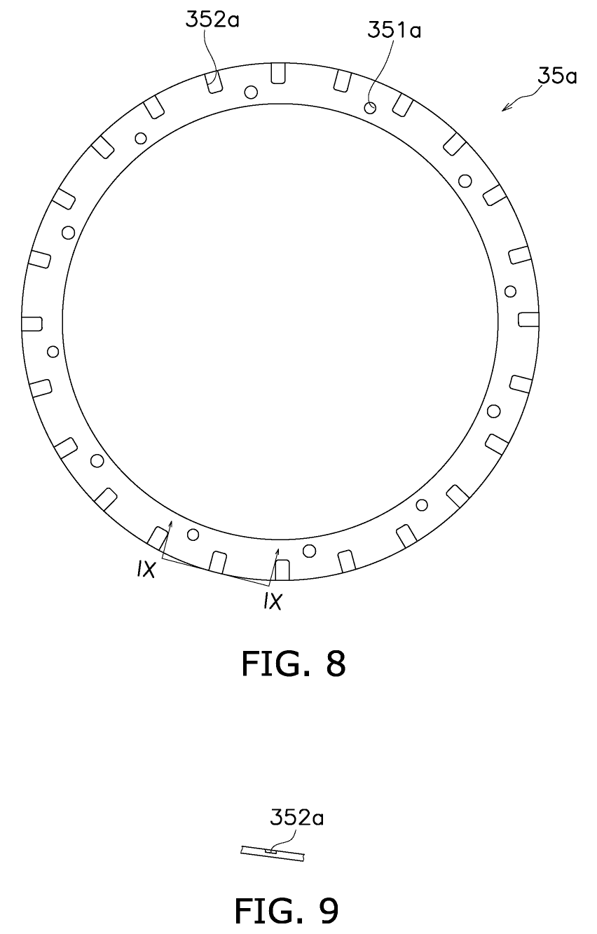

FIG. 8 is a front view of the first friction material 35a seen from the second side in the axial direction, whereas FIG. 9 is a cross-sectional view of the first friction material 35a taken along arrowed line IX-IX in FIG. 8. As shown in FIGS. 8 and 9, the first friction material 35a includes a plurality of grooves 352a. The grooves 352a are disposed away from each other at intervals in the circumferential direction. The grooves 352a are disposed at equal pitches to the engaging tabs 343. Each groove 352a has a width larger than that of each engaging tab 343. When described in detail, the width of each groove 352a is larger than that of the extending portion 344 of each engaging tab 343. Not only the width of each groove 352a but also that of each engaging tab 343 herein means the circumferential dimension thereof. Each groove 352a extends in the radial direction. Each groove 352a opens radially outward.

The grooves 352a are provided on one of both surfaces of the first friction material 35a, i.e., the surface thereof disposed adjacent to the support plate 33 and the auxiliary plates 34. In other words, the grooves 352a are provided on one of both surfaces of the first friction material 35a, i.e., the surface thereof oriented to the second side in the axial direction. The grooves 352a are provided not to penetrate the first friction material 35a in the axial direction.

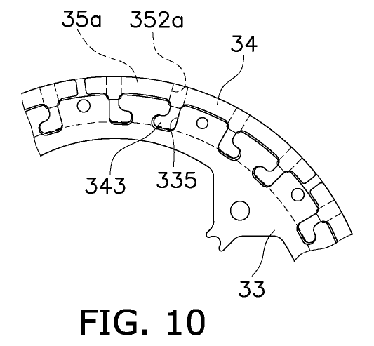

FIG. 10 is an enlarged front view of the support plate 33 to which the auxiliary plates 34 and the first friction material 35a are attached. As shown in FIG. 10, each groove 352a overlaps with a boundary between each engaging slit 335 and each engaging tab 343 as seen in the axial direction. Accordingly, when water is trapped in a gap between each engaging slit 335 and each engaging tab 343, it is made possible to discharge the trapped water to the outside through each groove 352a. It is preferable for each groove 352a to overlap with a root portion of each engaging tab 343 as seen in the axial direction.

As shown in FIG. 2, the second friction material 35b is disposed axially between the support plate 33 and the second side plate 32. The second friction material 35b is disposed adjacent to the support plate 33 and the auxiliary plates 34 in the axial direction. The second friction material 35b is identical in configuration to the first friction material 35a. In other words, the second friction material 35b includes the plural second through holes 351b and a plurality of grooves (omitted in illustration). It should be noted that the second friction material 35b may not be provided with the grooves.

The second through holes 351b penetrate the second friction material 35b in the axial direction. The second friction material 35b is attached to the support plate 33. When described in detail, the second protruding portions 332 of the support plate 33 are engaged with the second through holes 351b of the second friction material 35b, respectively, whereby the second friction material 35b is attached to the support plate 33. The second friction material 35b is rotated unitarily with the support plate 33.

The second friction material 35b has an annular shape. The second friction material 35b extends across the support plate 33 and the auxiliary plates 34. In other words, the second friction material 35b overlaps with both the support plate 33 and the auxiliary plates 34 as seen in the axial direction. The second friction material 35b has an inner diameter smaller than the outer diameter of the support plate 33. The second friction material 35b has an outer diameter larger than that of the support plate 33. Besides, the outer diameter of the second friction material 35b is less than or equal to that of each auxiliary plate 34. It should be noted that in the present preferred embodiment, the outer diameter of the second friction material 35b is substantially equal to that of each auxiliary plate 34.

### Pressure Plate

The pressure plate 36 has an annular shape. The pressure plate 36 is disposed axially between the disc spring 37 and the support plate 33. When described in detail, the pressure plate 36 is disposed axially between the first friction material 35a and the disc spring 37. The pressure plate 36 has an inner diameter smaller than that of the first friction material 35a. Besides, the pressure plate 36 has an outer diameter larger than that of the first friction material 35a. In other words, the pressure plate 36 is enabled to press the entire surface of the first friction material 35a.

The pressure plate 36 is configured to be rotated unitarily with the second side plate 32. It should be noted that the pressure plate 36 is axially movable with respect to the second side plate 32.

### Disc Spring

The disc spring 37 is disposed axially between the support plate 33 and the first side plate 31. When described in detail, the disc spring 37 is disposed axially between the first side plate 31 and the pressure plate 36. The disc spring 37 urges the pressure plate 36 to the second side in the axial direction. In other words, the disc spring 37 urges the pressure plate 36 toward the support plate 33. Accordingly, the support plate 33, the first friction material 35a, and the second friction material 35b are sandwiched by the pressure plate 36 and the second side plate 32.

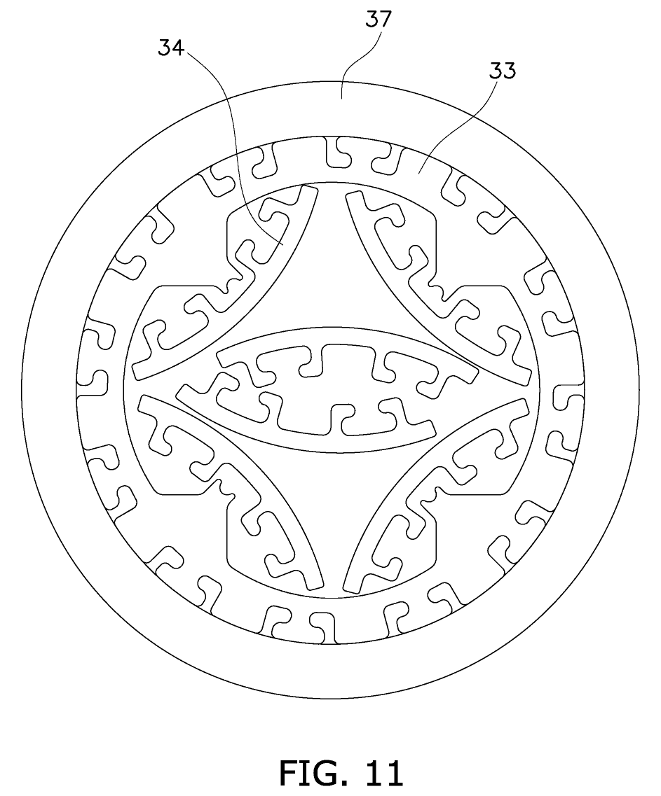

The disc spring 37 has an annular shape. As shown in FIG. 11, the disc spring 37 is taken together with the support plate 33 from a sheet of plate by nested-based manufacturing. Because of this, the disc spring 37 has an inner diameter greater than or equal to the outer diameter of the support plate 33. Besides, the disc spring 37 is equal in plate thickness to the support plate 33.

The plural auxiliary plates 34 are also taken together with the disc spring 37 and the support plate 33 from the sheet of plate by nested-based manufacturing. The plural auxiliary plates 34 are taken out from a region enclosed by the support plate 33. Because of this, each auxiliary plate 34 is also equal in plate thickness to the support plate 33. FIG. 11 is a plan view of the sheet of plate from which the support plate 33, the disc spring 37, and the plural auxiliary plates 34 are taken out.

As shown in FIG. 2, the disc spring 37 is in contact at an outer peripheral end portion thereof with the first side plate 31, while being in contact at an inner peripheral end portion thereof with the pressure plate 36. The inner peripheral edge of the disc spring 37 is disposed radially outside the outer peripheral edge of the support plate 33. Besides, the inner peripheral edge of the disc spring 37 is disposed radially inside the outer peripheral edge of each auxiliary plate 34. In other words, the disc spring 37 overlaps with the auxiliary plates 34 as seen in the axial direction. Because of this, it is made possible to evenly apply a load to the first friction material 35a.

### Modifications

One preferred embodiment of the present invention has been explained above. However, the present invention is not limited to the above, and it will be apparent to one of ordinary skill in the art from this disclosure that a variety of changes can be made without departing from the gist of the present invention. It should be noted that basically speaking, respective modifications to be described are applicable separately or in combination in an embodiment.

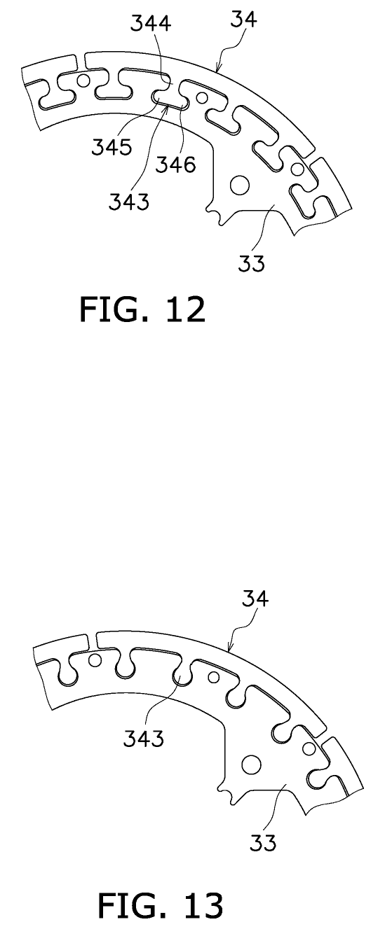

(a) In the preferred embodiment described above, each engaging tab 343 includes the extending portion 344 and the hook portion 345; however, each engaging tab 343 is not limited in configuration to this. For example, as shown in FIG. 12, each engaging tab 343 may include the extending portion 344, a first hook portion 345, and a second hook portion 346. The first and second hook portions 345 and 346 extend from the extending portion 344 in the circumferential direction. The first and second hook portions 345 and 346 extend away from each other to the opposite sides.

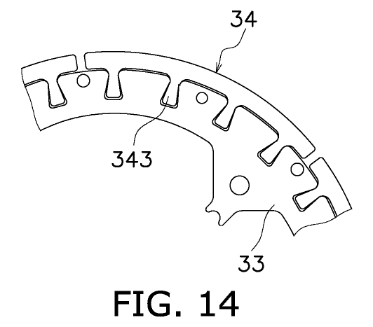

(b) Each engaging tab 343 may be shaped to include a portion with a width gradually increasing radially inward. For example, each engaging tab 343 may be made in the shape of a teardrop as shown in FIG. 13; alternatively, each engaging tab 343 may be made in the shape of a triangle as shown in FIG. 14. It should be noted that the width of each engaging tab 343 means the circumferential dimension thereof.

(c) In the preferred embodiment described above, the first friction material 35a includes the grooves 352a; however, the first friction material 35a may not include the grooves 352a.

(d) The first and second friction materials 35a and 35b may be attached not to the support plate 33 but to the auxiliary plates 34. Besides, the first and second friction materials 35a and 35b may be attached to the support plate 33 or the auxiliary plates 34 by any other suitable means such as an adhesive.

### LIST OF REFERENCE NUMERALS

3: Torque limiter, 31: First side plate, 32: Second side plate, 33: Support plate, 331: First protruding portion, 332: Second protruding portion, 333: First region, 334: Second region, 335: Engaging slit, 34: Auxiliary plate, 342: Plate body, 343: Engaging tab, 344: Extending portion, 345: Hook portion, 35a: First friction material, 351a: First through hole, 351b: Second through hole, 352a: Groove, 35b: Second friction material, 36: Pressure plate, 37: Disc spring, 4: Damper unit, 41: Input rotor, 42: Output rotor, 43: Elastic member, 100: Power transmission device.

The term "comprising" and its derivatives, as used herein, are intended to be open ended terms that specify the presence of the stated features, elements, components, groups, integers, and/or steps, but do not exclude the presence of other unstated features, elements, components, groups, integers and/or steps. This concept also applies to words of similar meaning, for example, the terms "have," "include" and their derivatives.

The terms "member," "section," "portion," "part," "element," "body" and "structure" when used in the singular can have the dual meaning of a single part or a plurality of parts.

The ordinal numbers such as "first" and "second" recited in the present application are merely identifiers, but do not have any other meanings, for example, a particular order and the like. Moreover, for example, the term "first element" itself does not imply an existence of "second element," and the term "second element" itself does not imply an existence of "first element."

The term "plurality," as used herein, can encompass the configuration in which each element of a plurality of elements has a different shape or structure from each other in addition to the configuration in which the plurality of elements have the same shapes or structures as each other.

The terms "a" (or "an"), "one or more" and "at least one" can be used interchangeably herein. The phrase "at least one of" as used in this disclosure means "one or more" of a desired choice.

Terms of degree such as "substantially," "about" and "approximately" as used herein mean a reasonable amount of deviation of the modified term such that the end result is not significantly changed. All of numerical values described in the present application can be construed as including the terms such as "substantially," "about" and "approximately."

Modifications and variations of the present invention will be apparent to one of ordinary skill in the art in light of this disclosure. It is therefore to be understood that within the scope of the appended claims, the invention may be practiced otherwise than as specifically described herein.

1. A torque limiter comprising:
a first side plate having an annular shape;
a support plate having an annular shape, the support plate disposed away from the first side plate at an interval in an axial direction;
a plurality of auxiliary plates attached to the support plate, the plurality of auxiliary plates disposed radially outside the support plate, the plurality of auxiliary plates aligned in an annular shape;
a disc spring disposed between the first side plate and the support plate in the axial direction; and
a first friction material disposed between the support plate and the disc spring in the axial direction, the first friction material disposed adjacent to the support plate and each of the plurality of auxiliary plates,
the support plate including a plurality of engaging slits extending radially inward from an outer peripheral surface thereof,
the each of the plurality of auxiliary plates including a plate body and an engaging tab, the plate body extending in a circumferential direction, the engaging tab extending radially inward from the plate body, the engaging tab engaged with one of the plurality of engaging slits, and
the engaging tab being configured to be hooked on an interior of the one of the plurality of engaging slits so as to restrict the each of the plurality of auxiliary plates from moving radially outward.

2. The torque limiter according to claim 1, wherein the engaging tab includes an extending portion and a hook portion, the extending portion extending radially inward from the plate body, the hook portion extending from the extending portion in the circumferential direction.

3. The torque limiter according to claim 2, wherein
the each of plurality of the auxiliary plates includes a pair of the engaging tabs, and
the hook portion of the one of the pair of engaging tabs and the hook portion of the other of the pair of engaging tabs extend toward each other in the circumferential direction.

4. The torque limiter according to claim 3, wherein
the support plate includes a pair of protruding portions protruding in the axial direction, and
the pair of engaging tabs is disposed between the pair of protruding portions in the circumferential direction.

5. The torque limiter according to claim 1, wherein
the first friction material includes a groove on a surface thereof disposed adjacent to the support plate and the each of the plurality of auxiliary plates, the groove opening radially outward, and
the groove overlaps with a boundary between the engaging tab and the one of the plurality of engaging slits as seen in the axial direction.

6. The torque limiter according to claim 1, further comprising:
a second side plate having an annular shape, the second side plate disposed to interpose the support plate, the each of the plurality of auxiliary plates, the disc spring, and the first friction material together with the first side plate therebetween;
a pressure plate disposed between the disc spring and the first friction material in the axial direction; and
a second friction material disposed between the support plate and the second side plate in the axial direction.

7. The torque limiter according to claim 1, further comprising:
a second side plate having an annular shape, the second side plate disposed to interpose the support plate, the each of the plurality of auxiliary plates, the disc spring, and the first friction material together with the first side plate therebetween;
a pressure plate disposed between the disc spring and the first friction material in the axial direction; and
a second friction material disposed between the support plate and the second side plate in the axial direction, wherein
the first friction material includes a first through hole penetrating therethrough in the axial direction,
the second friction material includes a second through hole penetrating therethrough in the axial direction,
the support plate includes
a first protruding portion protruding toward the first friction material, the first protruding portion engaged with the first through hole,
a second protruding portion protruding toward the second friction material, the second protruding portion engaged with the second through hole,
a first region defined by one pair of engaging slits disposed adjacent to each other in the circumferential direction among the plurality of engaging slits, the first region provided with the first protruding portion, and
a second region defined by another pair of engaging slits disposed adjacent to each other in the circumferential direction among the plurality of engaging slits, the second region provided with the second protruding portion,
the first region is shaped to bend toward the first friction material, the first region extended straight when sandwiched by the pressure plate and the second side plate, and
the second region is shaped to bend toward the second friction material, the second region extended straight when sandwiched by the pressure plate and the second side plate.

8. The torque limiter according to claim 1, wherein an inner peripheral edge of the disc spring is disposed radially outside an outer peripheral edge of the support plate, the inner peripheral edge of the disc spring disposed radially inside an outer peripheral edge of the each of the plurality of auxiliary plates.

9. The torque limiter according to claim 1, wherein the disc spring is equal in plate thickness to the support plate.

10. A power transmission device comprising:
the torque limiter recited in claim 1; and
a damper unit including an input rotor, an output rotor, and an elastic member, the input rotor configured to be rotated unitarily with the support plate, the elastic member elastically coupling the input rotor and the output rotor therethrough to each other.

11. The torque limiter according to claim 1, wherein the engaging tab includes an extending portion, a first hook portion and a second hook portion.

12. The torque limiter according to claim 11, wherein the first and second hook portions extend from the extending portion in a circumferential direction.

13. The torque limiter according to claim 12, wherein the first and second hook portions extend away from each other to opposite sides.

14. The torque limiter according to claim 1, wherein the each of the plurality of auxiliary plates includes a two or more engaging tabs, and each of the engaging tabs is shaped to include a portion with a width gradually increasing radially inward.

15. The torque limiter according to claim 14, wherein the each of the engaging tabs is in the shape of a triangle.

16. The torque limiter according to claim 14, wherein the each of the engaging tabs is in the shape of a teardrop.

17. The torque limiter according to claim 2, wherein
the first friction material includes a groove on a surface thereof disposed adjacent to the support plate and the each of the plurality of auxiliary plates, the groove opening radially outward, and
the groove overlaps with a boundary between the engaging tab and the one of the plurality of engaging slits as seen in the axial direction.

18. The torque limiter according to claim 3, wherein
the first friction material includes a groove on a surface thereof disposed adjacent to the support plate and the each of the plurality of auxiliary plates, the groove opening radially outward, and
the groove overlaps with a boundary between the engaging tab and the one of the plurality of engaging slits as seen in the axial direction.

19. The torque limiter according to claim 2, further comprising:
a second side plate having an annular shape, the second side plate disposed to interpose the support plate, the each of the plurality of auxiliary plates, the disc spring, and the first friction material together with the first side plate therebetween;
a pressure plate disposed between the disc spring and the first friction material in the axial direction; and
a second friction material disposed between the support plate and the second side plate in the axial direction.

20. The torque limiter according to claim 2, further comprising:
a second side plate having an annular shape, the second side plate disposed to interpose the support plate, the each of the plurality of auxiliary plates, the disc spring, and the first friction material together with the first side plate therebetween;
a pressure plate disposed between the disc spring and the first friction material in the axial direction; and
a second friction material disposed between the support plate and the second side plate in the axial direction, wherein
the first friction material includes a first through hole penetrating therethrough in the axial direction,
the second friction material includes a second through hole penetrating therethrough in the axial direction,
the support plate includes
a first protruding portion protruding toward the first friction material, the first protruding portion engaged with the first through hole,
a second protruding portion protruding toward the second friction material, the second protruding portion engaged with the second through hole,
a first region defined by one pair of engaging slits disposed adjacent to each other in the circumferential direction among the plurality of engaging slits, the first region provided with the first protruding portion, and
a second region defined by another pair of engaging slits disposed adjacent to each other in the circumferential direction among the plurality of engaging slits,the second region provided with the second protruding portion,
the first region is shaped to bend toward the first friction material, the first region extended straight when sandwiched by the pressure plate and the second side plate, and
the second region is shaped to bend toward the second friction material, the second region extended straight when sandwiched by the pressure plate and the second side plate.
